(19) United States
(12) Patent Application Publication
(10) Pub. No.: US 2012/0038705 A1
(43) Pub. Date: Feb. 16, 2012

(54) Method and Apparatus for Delivering Ink Material from a Discharge Nozzle

(75) Inventors: Conor Francis Madigan, San Francisco, CA (US); Jianglong Chen, San Jose, CA (US); Dariusz Golda, Redwood City, CA (US); Hyeun-Su Kim, Palo Alto, CA (US); Valerie Gassend, San Carlos, CA (US); Manush Birang, Los Gatos, CA (US)

(73) Assignee: KATEEVA, INC., Menlo Park, CA (US)

(21) Appl. No.: 13/218,451

(22) Filed: Aug. 26, 2011

Related U.S. Application Data
(63) Continuation of application No. 12/139,409, filed on Jun. 13, 2008.
(60) Provisional application No. 61/453,098, filed on Mar. 15, 2011.
(60) Provisional application No. 60/944,000, filed on Jun. 14, 2007.

(51) Int. Cl. B41J 2/175

(52) U.S. Cl. 347/20; 347/85

(57) ABSTRACT

The disclosure relates to a method for loading ink material into discharge nozzle having a non-discharge surface and a plurality of micropores. The, method includes the steps of providing a quantity of liquid ink material defined by a carrier fluid containing dissolved or suspended film material; delivering the quantity of liquid ink onto the discharge nozzle and directing a portion of the delivered ink into at least one micropore; flowing a pressurized gas over the surface to drive the delivered ink material into the least one nozzle; evaporating the carrier fluid from the delivered ink to form a substantially carrier-free ink material at the micropore; and dispensing the substantially carrier-free ink material from the nozzle. The surface can be configured to reject the ink and the plurality of nozzles are configured to receive the ink.

The instant application claims priority to provisional application No. 61/453,098, filed Mar. 15, 2011 and to patent application Ser. No. 12/139,409, filed Jun. 13, 2008, which claims priority to provisional application No. 60/944,000, filed Jun. 14, 2007, the disclosure of the identified applications are incorporated herein in their entirety.

### BACKGROUND

1. Field of the Invention

The disclosure relates to method and apparatus for efficiently depositing patterns of film on a substrate. More specifically, the disclosure relates to a method and apparatus for providing ink to a deposition apparatus for depositing an organic film on a substrate.

2. Description of Related Art

The manufacture of light emitting devices requires depositing one or more organic films on a substrate and coupling the top and bottom of the film stack to electrodes. The film thickness is a prime consideration and the deposition process must be optimized to deliver optimal thickness uniformity. The printing is typically accomplished by introducing liquid ink containing film material dissolved or suspended in a carrier fluid onto a discharge nozzle which then delivers all or part of the received film material onto the substrate.

The liquid ink is typically stored in a reservoir and is delivered to a discharge array. The discharge array comprises a multitude of interconnected discharge nozzles arranged in rows and columns. Each discharge nozzle prints a pixel on the substrate. The discharge nozzles typically comprise one or more micropores. The micropores receive liquid ink from the ink reservoir at a surface proximal thereto and dispense the ink material onto the substrate from their distal surface. The ink material can be dispensed in substantially vapor phase so as to allow formation of a film layer on the substrate in the absence of a carrier fluid.

Each discharge nozzle is spaced apart from its adjacent discharge nozzles. Although the liquid ink is intended to be delivered directly to the microarrays of each discharge nozzle, misalignment issues prevent complete delivery and only a fraction of the supplied ink makes its way to the micropores. The ratio of the quantity of liquid ink entering the pores compared to the quantity of liquid ink (including dissolved or suspended material) remaining or drying on the surface is called ink loading efficiency. When a large amount of liquid is supplied to the discharge array but only a small portion of the ink material makes its way into the micropores, the system is considered to have low loading efficiency. Moreover, when liquid ink material is finally delivered to the micropores, one or more solid particles can clog a micropore and thereby cause incomplete discharge.

Accordingly, there is a need for a method and apparatus that allows filling the micropores uniformly even if liquid ink is delivered some distance away from the region of interest with high loading efficiency.

### SUMMARY

The disclosure relates to a method and apparatus for efficiently depositing a film on a substrate. More specifically, the disclosure relates to a method and apparatus for directing liquid ink containing dissolved or suspended OLED material to a printhead surface in order to form an OLED film on the substrate. The OLED film can be substantially-free from carrier fluid and the delivery system is optimized to increase the loading efficiency.

An exemplary implementation of the disclosure relates to a method for loading film material into a discharge array. The discharge array includes a surface and a plurality of micropores extending through the surface. The discharge array is interposed between a liquid ink delivery system and a substrate. The liquid ink delivery system may include a plurality of nozzles which correspond to, and are aligned, with the plurality of micropores. The nozzles deliver liquid ink comprising of a carrier fluid having suspended or dissolved film material therein.

After a quantity of liquid ink is delivered to the discharge array, only a portion of the delivered ink is received at the micropores and the balance is received at the surface of the array. A pressurized gas knife is then moved over the discharge array to drive the delivered ink material to the micropores. The carrier fluid is removed from the delivered ink to form a substantially carrier-free ink material at the micropores prior to dispensing the substantially carrier-free film material from the micropores.

In another embodiment of the disclosure, the non-discharge surfaces and the micropores are treated such that the non-discharge surfaces repel liquid ink while the micropores attract the liquid ink. The treatment can be one of chemical treatments (i.e., coating with a repellant or attracting chemical), a physical treatment (i.e., differential surface roughness etching or other forms of solid surface treatment), an electrochemical treatment (i.e., anodic treatment) or a combination of these treatments.

In still another embodiment, the disclosure relates to an apparatus for loading ink material into discharge system. The apparatus comprises an ink discharge system defined by an array having a surface and at a first micropore extending through the surface; an ink supply for delivering liquid ink to the discharge system, the liquid ink can be defined by a carrier fluid containing dissolved or suspended film material therein; a gas knife for directing pressurized gas to the surface and the first micropore to distribute liquid ink across the surface and into the first micropore; and an energy source for evaporating the carrier fluid from the delivered liquid ink to thereby leave a substantially carrier-free film material in the first micropore. The energy source can comprise a heater. The micropore can be configured to receive the ink and the surrounding surfaces can be configured to repel the ink. The film that forms on the substrate can be a substantially carrier-free layer of an organic light emitting diode.

In yet another embodiment, the disclosure relates to a method for depositing a film material on a substrate by (1) supplying a quantity of liquid ink defined by a carrier fluid containing dissolved or suspended ink material to an array defined by a first surface having a plurality of blind micropores extending therethrough; (2) repelling the liquid ink from the first surface of the array toward a first of the plurality of blind micropores; (3) receiving the liquid ink at the first micropore; (4) flowing a pressurized gas over the surface to drive the liquid ink into the first micropore; (5) removing the carrier fluid from the delivered ink to form a substantially carrier-free ink material at the first micropore; and (6) dispensing the substantially carrier-free ink material from the at least one micropore to form the film on a substrate.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1A provides a schematic representation of a thermal jet print-head which can be used with an embodiment of the disclosure;

FIG. 1B is a schematic representation of an apparatus for depositing a film according to still another embodiment of the disclosure;

FIGS. 2A-2D schematically illustrate the process of depositing a solvent-free material using a print-head apparatus according to an embodiment of the disclosure;

FIG. 3A-3C schematically illustrate representative discharge arrays;

FIG. 4 is an exemplary embodiment of a gas knife according to one embodiment of the disclosure;

FIG. 5 is an exemplary embodiment of the surface of an exemplary discharge nozzle;

FIG. 6A shows a pore array according to an embodiment of the disclosure;

FIGS. 6B and 6C are schematic representations of an embodiment of the invention.

FIG. 7 shows a discharge nozzle having an interconnected channel structure;

FIGS. 8A-8D schematically illustrate cross-sections of exemplary micropore structures; and

FIG. 9 schematically illustrates top views of exemplary micropores.

### DETAILED DESCRIPTION

In one embodiment, the disclosure relates to a method and apparatus for depositing a film substantially free from carrier liquid on a substrate. In another embodiment, the disclosure relates to a method and apparatus for depositing a film of material in a substantially solid form on a substrate. In another embodiment, the disclosure relates to a method and apparatus for depositing a film of material substantially free of solvent onto a substrate. Such films can be used, for example, in the design and construction of OLEDs and large area transistor circuits. The materials that may be deposited by the apparatuses and methods described herein include organic materials, metal materials, and inorganic semiconductors and insulators, such as inorganic oxides, chalcogenides, Group IV semiconductors, Group III-V compound semiconductors, and Group II-VI semiconductors.

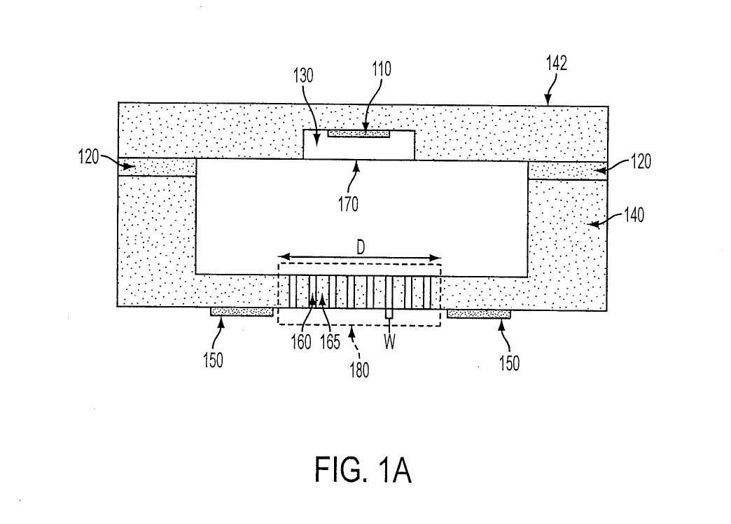

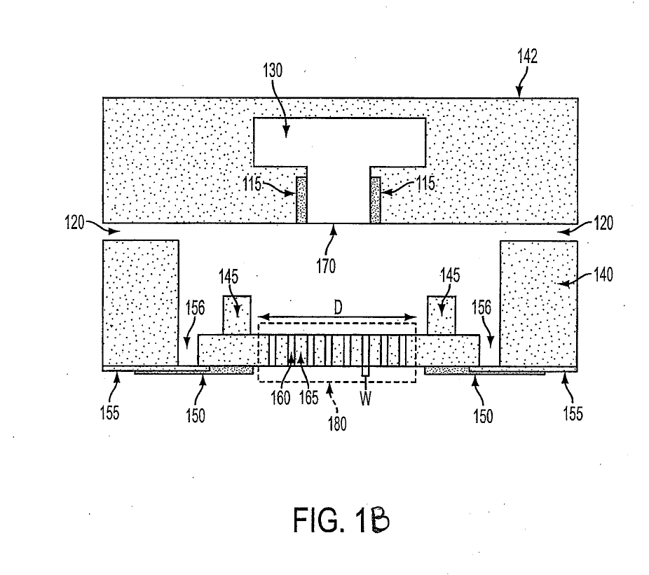

FIG. 1A provides a schematic representation of a thermal jet print-head which can be used with implementation of the disclosure. Referring to FIG. 1A, the exemplary apparatus for depositing a material on a substrate comprises reservoir 130, orifice 170, nozzle 180, and micro-porous conduits 160 (interchangeably, micropores 160). Reservoir 130 receives ink in liquid form and communicates the ink from orifice 170 to discharge nozzle 180. The exemplary ink can be defined by a carrier fluid containing dissolved or suspended film material therein. These dissolved or suspended film materials may comprise single molecules or atoms, or aggregations of molecules and/or atoms. The path between orifice 170 and discharge reservoir 180 defines a delivery path. In the embodiment of FIG. 1A, discharge nozzle 180 comprises conduits 160 separated by partitions 165. Conduits 160 may include micro-porous material therein. A surface of discharge nozzle 180 proximal to orifice 170 defines the inlet port to discharge nozzle 180 while the distal surface of discharge nozzle 180 defines the outlet port. A substrate (not shown) can be positioned proximal to the outlet port of discharge nozzle 180 for receiving ink deposited from the nozzle.

While reservoir 130 appears in alignment with discharge nozzle 180, in practice the two may be misaligned. Consequently, the ink liquid ink is dropped over the exposed surface area adjacent discharge nozzle 180 and not into micropores 160. This misalignment causes poor loading efficiency as significantly less ink or film material makes its way to the micropore and ultimately onto the substrate.

The thermal jet print-head of FIG. 1A further includes bottom structure 140, which receives discharge nozzle 180. Discharge nozzle 180 can be fabricated as part of the bottom structure 140. Alternatively, discharge nozzle 180 can be manufactured separately and later combined with bottom structure 140 to form an integrated structure. Top structure 142 receives reservoir 130. Top structure 142 can be formed with appropriate cavities and conduits to form reservoir 130. Top structure 142 and bottom structure 140 are coupled through bonds 120 to form a housing. A heater 110 can be optionally added to reservoir 130 for heating and/or dispensing the ink. In FIG. 1A, heater 110 is positioned inside reservoir 130.

Discharge nozzle 180 includes partitions (or rigid portions) 165 separated by micropores 160. Micropores 160 and rigid portions 165 can collectively define a micro porous environment. The micro-porous environment can be composed of a variety of materials, including, micro-porous alumina or solid membranes of silicon or silicon carbide and having micro-fabricated pores. Micropores 160 prevent the material dissolved or suspended in the liquid from escaping through discharge nozzle 180 until the medium is appropriately activated. When the discharged droplet of liquid encounters discharge nozzle 180, the liquid is drawn into micropores 160 with assistance from capillary action. The carrier fluid in the quantity of ink may evaporate prior to activation of discharge nozzle 180, leaving behind a coating of the dissolved or suspended film material on the micropore walls. The carrier fluid may comprise one or more solvents with a relatively low vapor pressure. The carrier fluid may also comprise one or move solvents with a relatively high vapor pressure.

The evaporation of the carrier fluid may be accelerated by heating the discharge nozzle. The evaporated carrier fluid can be removed from the reservoir and subsequently collected (not shown), for instance, by flowing gas over one or more of the discharge nozzle faces. Depending on the desired application, micropores 160 can provide conduits (or passages) having a maximum linear cross sectional distance W of a few nanometers to hundreds of micrometers. The microporous region comprising discharge nozzle 180 will take a different a shape and cover a different area depending on the desired application, with a typical maximum linear cross-sectional dimension D ranging from a few hundred nanometers to tens of millimeters. In one embodiment, the ratio of W/D is in a range of about 1/10 to about 1/1000.

In the exemplary apparatus of FIG. 1A, discharge nozzle 180 is energized by nozzle heater 150. Nozzle heater 150 can be positioned proximal to discharge nozzle 180. Nozzle heater 150 may comprise a thin metal film. The thin metal film can comprise, for example, platinum. When activated, nozzle heater 150 provides pulsating thermal energy to discharge nozzle 180, which acts to dislodge the material contained within micropores or conduits 160, which can subsequently flow out from the discharge nozzle. In one embodiment, the pulsations can be variable on a time scale of one minute or less.

Dislodging the dissolved or suspended film material may include vaporization, either through sublimation or melting and subsequent boiling. It should be noted again that the term dissolved or suspended film material is used generally, and includes anything from a single molecule or atom to a cluster of molecules or atoms. In general, one can employ any energy source coupled to the discharge nozzle that is capable of energizing discharge nozzle 180 and thereby discharging the film material from micropores 160; for instance, mechanical (e.g., vibrational).

FIG. 1B is a schematic representation of an apparatus for depositing a film according to still another embodiment of the disclosure. In the exemplary apparatus of FIG. 1B, optional confining well 145 is introduced. This structure mechanically confines the quantity of liquid ink, or any other material, supplied to discharge nozzle 180 from ink reservoir 130 through reservoir orifice 170. This structure can enhance the uniformity of the loading of ink into micropores 160 and can correct for positioning errors in the placement of ink material supplied to discharge nozzle 180 from ink reservoir 130. FIG. 1B also shows connective regions 155 and gaps 120, which separate two parts of the housing. Connective regions 155 are used to connect discharge nozzle 180 to bottom structure 140. FIG. 1B also shows heater 150 extending beneath brackets 155 to reach discharge nozzle 180.

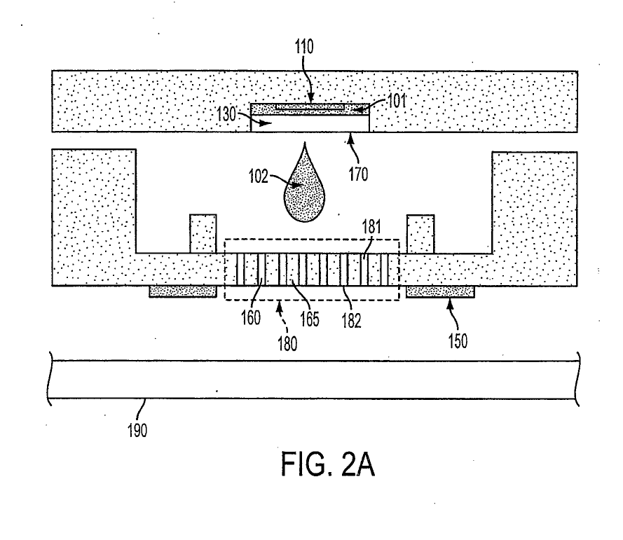

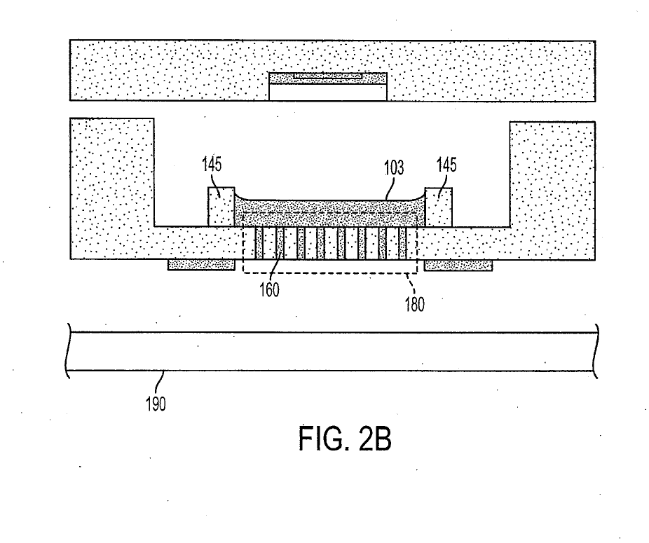

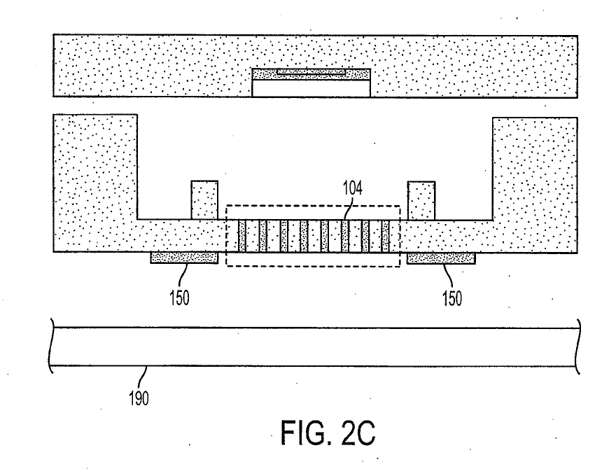

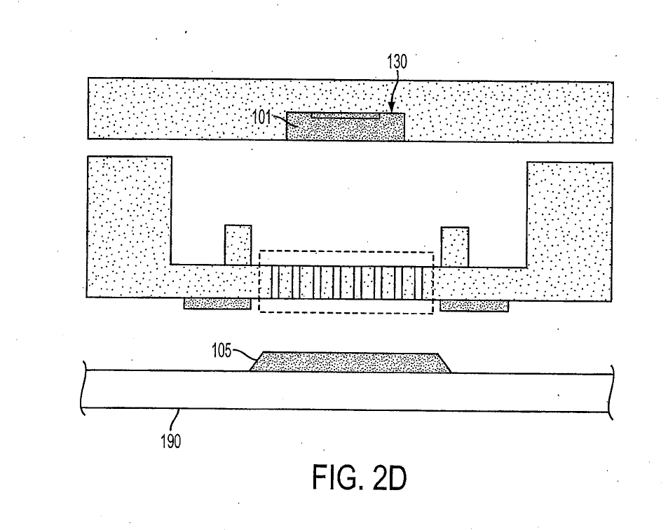

FIGS. 2A-2D schematically show the process of depositing film on a substrate according to one embodiment of the disclosure. In FIG. 2A, liquid ink 101 is commissioned to reservoir 130. Ink 101 can have a conventional composition. In one embodiment, ink 101 is a liquid ink defined by a carrier fluid containing dissolved or suspended particles therein.

Referring again to FIG. 2A, reservoir heater 110 comprises the ink dispensing mechanism and pulsatingly imparts thermal energy into liquid ink 101. The thermal energy drives at least a portion of liquid ink 101 through orifice 170 to form ink droplet 102. Ink droplet 102 can define all of, or a portion of liquid ink 101. The pulsating impartment of energy from an energy source (e.g., heater 110) determines the quantity of liquid ink to be metered out from reservoir 130. Once droplet 102 is metered out of reservoir 130, it is directed to discharge nozzle 180.

In another exemplary embodiment, piezoelectric elements (not shown) can be positioned at or near reservoir 130 to meter out the desired quantity of ink 101 through orifice 170, thereby forming droplet 102. In yet another exemplary embodiment, liquid can be streamed out of reservoir 130 through orifice 170 (by, for instance, maintaining a positive ink pressure) and this stream can be pulsatingly interrupted by a mechanical or electrostatic force such that metered droplets created from this stream and further directed onto discharge nozzle 180. If mechanical force is utilized, it can be provided by introducing a paddle (not shown) that pulsatingly intersects the stream. If electrostatic force is utilized, it can be provided by introducing a capacitor (not shown) around the stream that pulsatingly applies an electromagnetic field across the stream. Thus, any pulsating energy source that activates a dispensing mechanism and thereby meters liquid ink 101 delivered from reservoir 130 through orifice 170 and to discharge nozzle 180 can be utilized. The intensity and the duration of each energy pulse can be defined by a controller (not shown) which is discussed below. Furthermore, as noted above, this metering can occur primarily when the ink is ejected from reservoir 130 through orifice 170; alternatively, this metering can occur primarily while the ink is traveling from orifice 170 to discharge nozzle 180.

As discussed in the exemplary embodiments of FIGS. 1A and 1B, discharge nozzle 180 includes micropores for receiving and transporting metered liquid ink 102 to the substrate. Discharge nozzle heater 150 is placed proximal to discharge nozzle 180 to heat the discharge nozzle. A heater can also be integrated with the discharge nozzle such that partitions 165 define the heating elements.

Discharge nozzle 180 has a proximal surface (alternatively, inlet port) 181 and a distal surface (alternatively, outlet port) 182. Proximal surface 181 and distal surface 182 are separated by a plurality of partitions 160 and micropores 165. Proximal surface 181 faces reservoir 130 and distal surface 182 faces substrate 190. Nozzle heater 150 can be activated such that the temperature of discharge nozzle 180 exceeds the ambient temperature which enables rapid evaporation of the carrier liquid from droplet 102 which is now lodged in conduits 160. Nozzle heater 150 may also be activated prior to energizing the ink dispenser (and metering ink droplet 102 as it travels from reservoir 130 through orifice 170 to discharge nozzle 180) or after droplet 102 lands on discharge nozzle 180. In other words, reservoir heater 110 and discharge heater 150 can be choreographed to pulsate simultaneously or sequentially.

In the next step of the process, liquid ink 103 (previously liquid ink droplet 102) is directed to inlet port 181 of discharge nozzle 180 between confining walls 145. Liquid ink 103 is then drawn through conduits 160 toward outlet port 182. The carrier fluid in liquid ink 103, which may fill conduits 160 extends onto the surrounding surface, with the extent of this extension controlled in part by the engineering of confining walls 145, may evaporate prior to activation of discharge nozzle 180, leaving behind on the micropore walls the dissolved or suspended film material (herein, solid ink material) 104 (FIG. 2C) that are substantially solid and which can be deposited onto substrate 190. Alternatively, the carrier fluid (FIG. 2B) may evaporate during activation of nozzle heater 150.

Activating nozzle heater 150 in FIG. 2C, provides pulsating energy to discharge nozzle 180 and dislodges solid ink material 104 from conduits 160. The result is shown in FIG. 2D. The intensity and the duration of each energy pulse can be defined by a controller (not shown.) The activating energy can be thermal energy. Alternatively, any energy source directed to discharge nozzle 180 which is capable of energizing discharge nozzle 180 to thereby discharge material 104 from conduits 160 (e.g., mechanical, vibrational, ultrasonic, etc.) can be used. Deposited film 105 is thus deposited in solid form substantially free of the carrier fluid present in liquid ink 101 (see FIG. 2A). That is, substantially all of the carrier fluid is evaporated from ink 103 while it travels through discharge nozzle 180. The evaporated carrier fluid, which typically comprises a mixture of one or more solvents, can be transported away from the housing by one or more gas conduits (not shown).

In an exemplary embodiment, ink material 104 is heated so as to evaporate the solid ink material and direct a vapor stream containing ink material 104 onto substrate 190. Substrate 190 is positioned proximal to discharge nozzle 180 for receiving the vaporized ink material to form thin film 105. Simultaneously, reservoir 130 is provided with a new quantity of liquid ink 101 for the next deposition cycle.

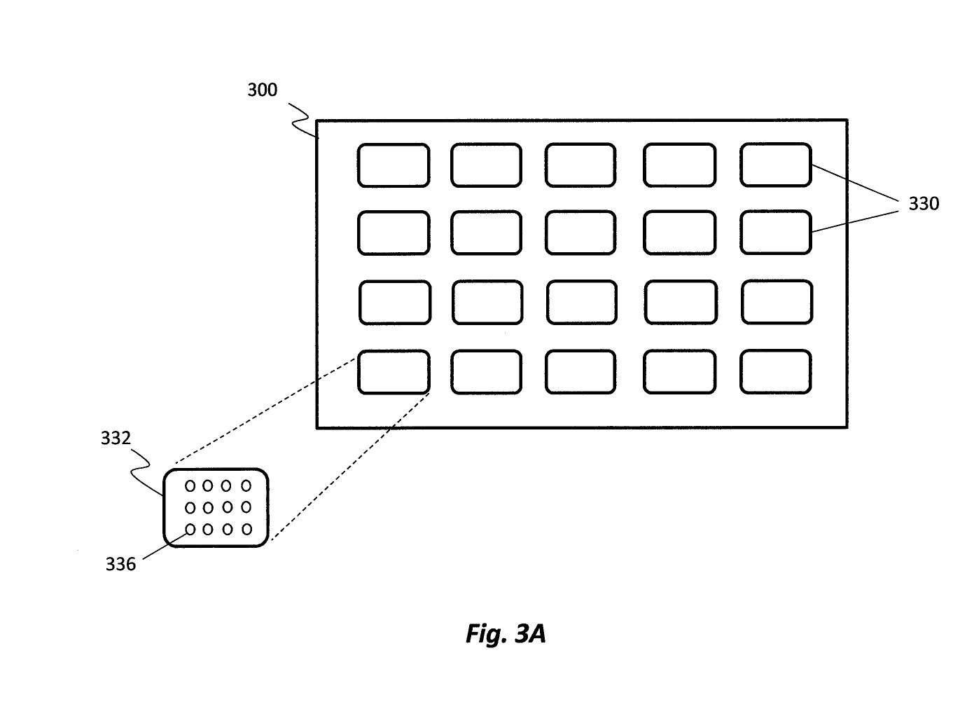

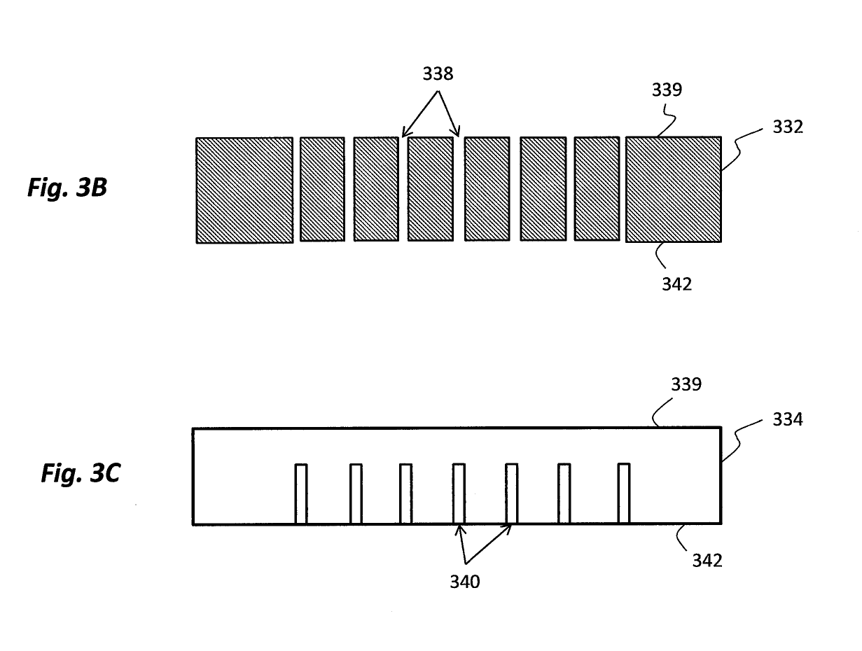

FIG. 3A a schematic representation of a discharge array. In FIG. 3, discharge array 330 includes a plurality of discharge nozzles 332 which appear in rows and columns for dispensing ink material onto a substrate. An exploded view of an exemplary discharge nozzle 332 is also provided showing a plurality of micropores 336. Micropores 336 can define conduits or any other forms suitable for receiving and transferring ink material.

Micropores can extend through the discharge nozzle or they can define blind micropores. FIGS. 3B and 3C illustrate these embodiments. Specifically, FIG. 3B shows micropores 338 extending from distal side 339 to the proximal side 342 of discharge nozzle 332. In contrast, FIG. 3C shows an embodiment in which micropores 340 are blind micropores extending partially through discharge nozzle 334. The blind micropores extend from proximal surface 342.

In an exemplary printing process each discharge nozzle receives liquid ink from one or more reservoirs (not shown). The discharge nozzles are preferably aligned with a corresponding liquid ink reservoir (see, for example, FIG. 1A). A controller meters liquid ink from each reservoir to a corresponding discharge nozzle. In practice, however, a portion of the supplied ink is received at the surface area separating adjacent discharge nozzles. This quantity of liquid ink fails to make its way into the micropores and often dries on the proximal surface of discharge array 300, causing gumming and other problems. Another continuing problem with the deposition material is the clogging of the pores and/or incomplete dispensing of material from the nozzle.

To address these and other problems, an embodiment of the disclosure is directed to a gas knife for providing a continuous gas stream over the proximal surface of the discharge array. The proximal surface of the discharge array receives ink from one or more reservoirs. Once a quantity of the liquid ink is delivered to the discharge nozzle, pressurized gas (or air) in the form of a gas knife is directed over a surface of the discharge nozzle. The gas knife distributes pressurized gas (or air) across a surface of the discharge nozzle driving the liquid ink into the micropores and away from the surfaces between adjacent micropores.

In the embodiment of FIG. 3B, discharge nozzle 332 is inked on distal surface 339. A gas knife provides pressurized gas to distal surface 339 to thereby drive the ink material into micropores 338. Ink material is deposited from proximal surface 342 onto the substrate (not shown). The gas knife helps drive ink material through micropores 332. In the embodiment of FIG. 3C, discharge nozzle 334 receives ink material on proximal surface 342. A gas knife is then used on proximal surface 342 to drive ink material into micropores 340. Thereafter, a substrate (not shown) can be positioned adjacent to proximal surface 342 to receive ink material therefrom.

FIG. 4 is an exemplary embodiment of a gas knife according to one embodiment of the disclosure. Specifically, FIG. 4 shows exemplary gas knife apparatus 400 having discharge 410 and lips 420. Gas knife 400 can be coupled to a gas source, a compressor or any other device capable of producing high pressure gas. Gas knife 400 may provide compressed air or a noble gas at ambient temperature or at elevated temperature. Lips 420 can form a slit opening to supply pressurized gas to the underlying structure. Apparatus 400 can be stationary with respect to the micropores or it can be move relative thereto.

After liquid ink is deposited on the micropores and the array surface (300 FIG. 3), pressurized gas is supplied by apparatus 400 and is targeted to the proximal surface of the discharge array 440. The flow of pressurized gas is shown by arrows 430. In an exemplary embodiment, apparatus 400 is moved over the array in order to distribute the delivered ink across the surface, and into each micropore. As stated, the pressurized gas can be at an elevated temperature to help evaporate the carrier fluid contained in the liquid ink.

Once the ink material is drawn into the micropores, pressurized gas can help further evaporate the carrier fluid and drive down the carrier-free ink material deeper into each micropore. Upon evaporation of the carrier fluid, substantially carrier-free ink material can be collected at each micropore and can be discharged onto the substrate in solid or vapor form. In one embodiment, substantially solid ink material is vaporized at the micropore and allowed to condense on the substrate surface as a substantially liquid-free film material. This process can be aided by a local heater proximal to, or integrated with, each discharge nozzle (see, for example, FIGS. 1A and 1B).

In an exemplary embodiment, the gas knife further includes a width and a length, which the sweeps along the longitude of the discharge nozzle. In one embodiment, the length of the gas knife is less than one third to total sweep distance, and the width is long enough to ensure complete coverage of the surface throughout the sweep.

In another embodiment, the liquid ink is delivered to and discharged from the proximal face of the micropores. The gas knife drives the delivered liquid ink into the micropores while simultaneously helping in evaporating and removing the carrier fluid from the proximal surface. It should be noted that the quantity of delivered ink can exceed the sum total of all of the available micropores' volume. Once the delivered ink material is received by the micropores, additional carrier fluid is evaporated, leaving behind a substantially solid ink material within each micropore. The gas knife will then help drive the substantially solid ink material through the micropores toward the distal face of the micropore. The substantially dry ink material is then vaporized and or ejected from the distal end onto a substrate, forming a substantially solid film thereon.

For blind pores, the ink can also be delivered in larger volume to the surface and spread using a flow of nitrogen or other gases through the gas knife. The gas used in the gas knife can be air, one or more noble gases or any combination thereof. The ink can then flow into the pores as it is passing above them but will not stay on the surface and will drain into the pores. This provides improved uniformity versus inkjet loading of the pores and removes leftover ink from the surfaces spanning between adjacent discharge nozzles (non-discharge surfaces). It also provides an alternative ink distribution structure to the orifice 170 while still allowing control over the amount of ink that is loaded in the pores. Alternatively, the flow of gas can be used in conjunction with inkjet printing or other methods to deliver a small volume of ink. Here, the purpose would be to remove leftover ink from the non-discharge surfaces.

In another embodiment, the non-discharge surfaces are modified to further aid micropore ink loading. Particularly, the non-discharge surfaces and the micropores can be treated such that non-discharge surfaces repel liquid ink while the micropores attract the liquid ink. The treatment can be one of chemical treatments (i.e., chemical coating to increase/decrease surface tension or surface energy), a physical treatment (i.e., etching or other forms of solid surface treatment to improve flow), an electrochemical treatment (i.e., anodic treatment) or a combination of these treatments. In still another embodiment, the non-discharge surfaces can be modified geometrically by changing the roughness of the material or creating steps, recesses or other structures with different height (e.g., fabricating ink wells). Super-wetting structures such as a multitude of pillars (i.e., a pillar forest to enhance flow of liquid ink) can be utilized on top of a pattern of pores or instead of a pattern pores.

Containment structures can also be used to prevent liquid ink from spreading onto the non-discharge surfaces. This is useful for open micropores on the sides opposite to the ink delivery mechanism to limit the effect of ink leaking through the micropores. A containment structure can be formed by creating a discontinuity in the surface wetting properties, such as with an abrupt change in surface material or topography. One containment structure is an oxide containment ring. For exemplary micropores etched in a silicon surface, an oxide ring is realized by etching silicon dioxide around the micropores down to bare silicon, and simultaneously patterning a 2-5 μm wide silicon dioxide ring around the pores. The size of the silicon dioxide ring is a function of the area to be contained and is not limited to the range provided herein.

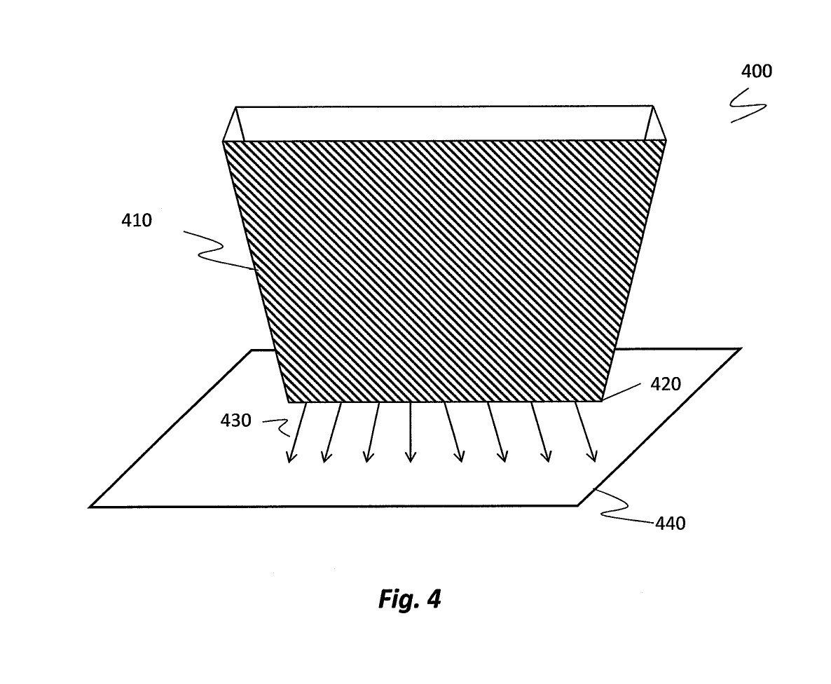

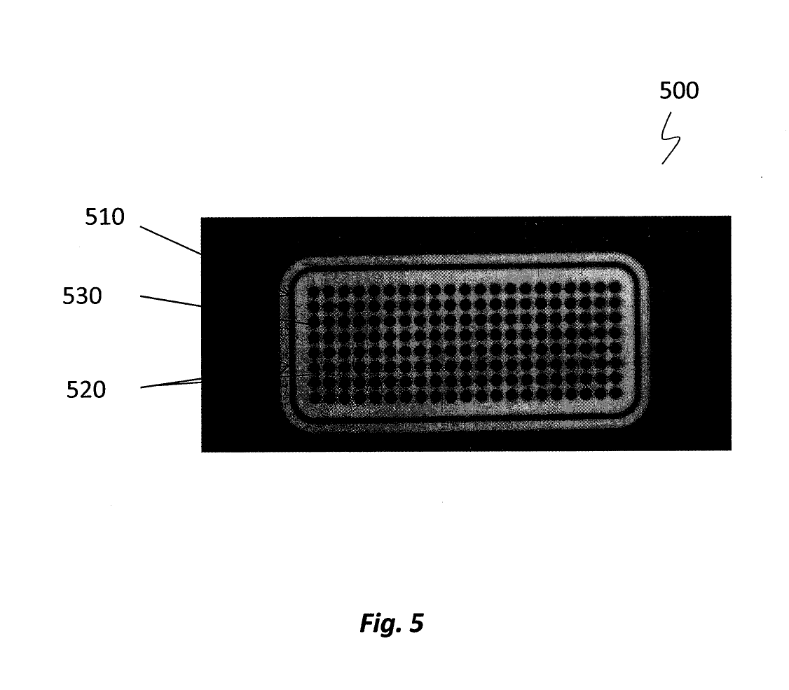

FIG. 5 is an exemplary embodiment of the surface of an exemplary discharge nozzle. More specifically, the embodiment of FIG. 5 depicts the surface of the discharge nozzle facing a substrate (the distal surface). Discharge surface 500 includes micropores 530 which are formed in silicon layer 520. Conventional MEMS processing can be used to form micropores 530. Although micropores 530 are shown as circular, the disclosure is not limited to this configuration. Other forms of micropores are discussed in greater detail below. Oxide ring 510 separates the outer portion of discharge surface 500 from micropores 530. Oxide ring 510 can be formed as a containment area. Alternatively, oxide ring 510 can have a composition configured to drive ink material towards micropores 530. A localized heater or a piezoelectric element may also be integrated with the discharge surface 500.

When liquid ink reaches the oxide ring, which is more hydrophilic as compared to silicon, the ink is prevented from further spreading due to the abrupt increase in contact angle and surface energy at the outer oxide-silicon interface of the ring. Ink spreading is therefore blocked by the ring. Liquid Ink can then retract back into the pores as it dries. A small volume of ink may remain on the ring.

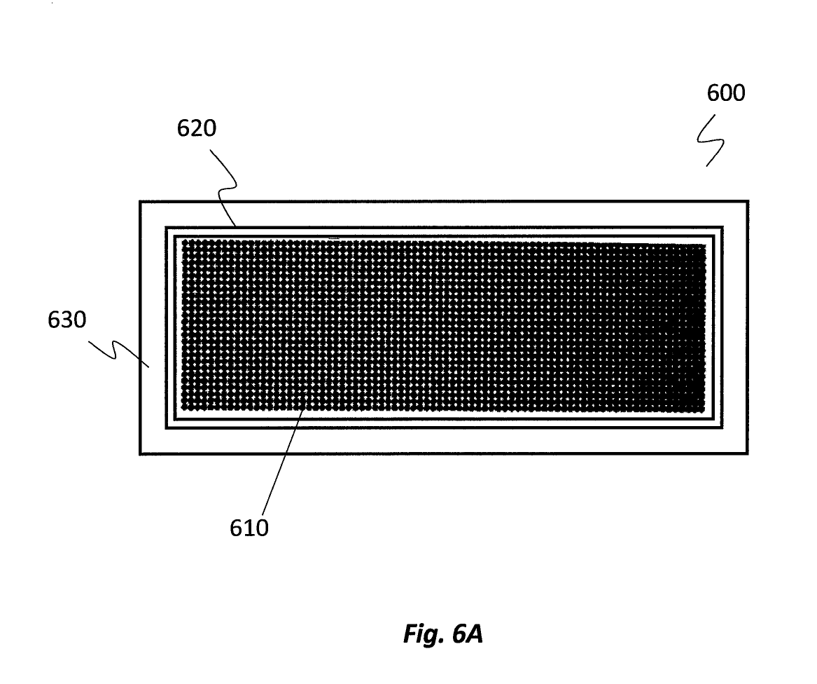

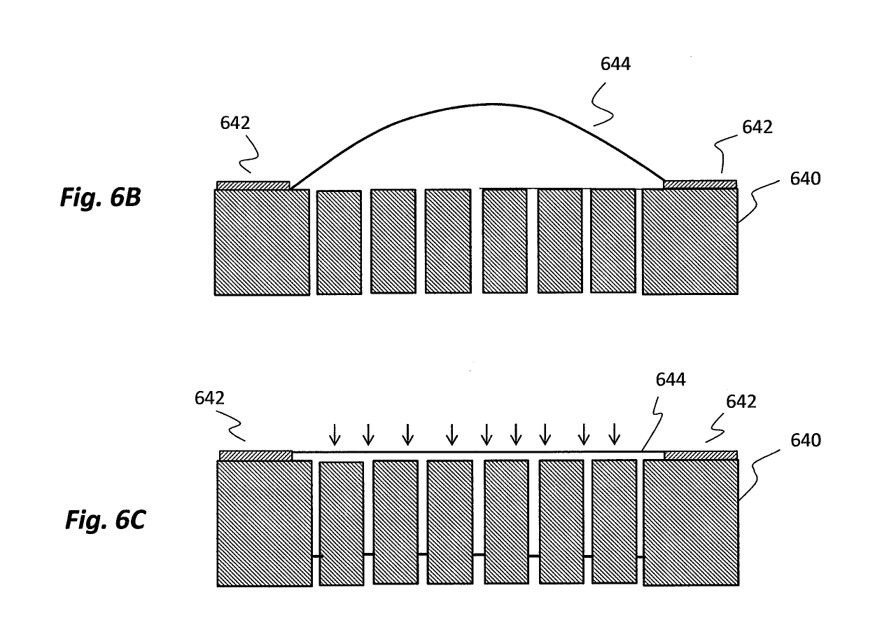

FIG. 6A shows a micropore array according to an embodiment of the disclosure. Micropore array 600 includes a multitude of pores 610 arranged in rows and columns. Each pore is rectangular in shape. Pore array 600 may also include heating apparatus 620 at periphery 630. The interior surface of pores 610 may be treated so as to attract the deposited liquid film material while surrounding area 630 can be treated to repel the same. The treatment may include, among others, physical treatment, chemical treatment and electrochemical treatment. By way of example, if the ink material contains water, the interior surfaces can be hydrophilic while the exterior and the periphery may be hydrophobic to thereby drive in the ink material into the micropores.

FIGS. 6B and 6C schematically show an embodiment of the invention in which a portion of the pore array is treated to repel liquid film material. Namely, surface areas 642 are coated with a material configured to repel the liquid film material. Coated surface 642 are on top of pore array 640. When liquid film material 642 is received on pore array 640, it is immediately drawn by top surfaces of pore array and by the micropores. Coated surfaces 642 repel the liquid film material 642. The molecular and capillary forces then draw in the liquid film material as shown in FIG. 6C. In an optional embodiment of the disclosure, external pressure can be provided, for example with a gas knife, to further draw the film material into the micropores.

It should be noted that the illustrated embodiments of FIGS. 6B and 6C apply equally to blind micropores. Here, the top surfaces of the micropores are coated with liquid film material. The film material is drawn to the micropores and repelled by the surrounding areas. An optional gas knife can assist driving the film material into the micropores. Micropore array 640 can then be used to dispense or deposit the film material onto a substrate.

To increase uniformity for the liquid ink loading into the micropores, the pattern of micropores as well as the pitch and relative positions of the pores can be modified. The micropores may also be replaced by interconnected channels so that the ink will spread uniformly inside the channels. This can also help with robustness to misalignment, and loading efficiency, as the channels will be more effective at drawing in liquid from the neighboring surface areas than pores.

FIGS. 6B and 6C also illustrate another embodiment of the disclosure in which the micropores are formed at a bottom of a shallow well defined by surfaces 642. According to this embodiment, the well forms containment for the liquid ink material.

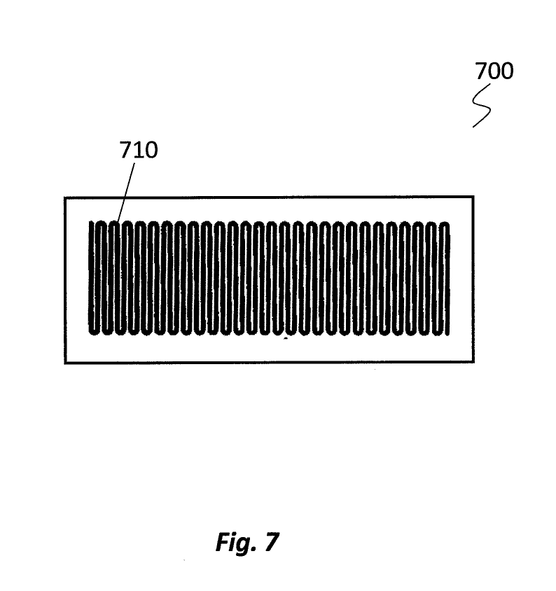

FIG. 7 shows a discharge nozzle having an interconnected channel structure. While the channel structure 700 of FIG. 7 contains a single channel 710, other pore structures can be devised within the scope of the disclosure whereby the pores are defined by discrete channels. As described in relation to FIGS. 6A-6C, the interior surfaces of the channel may be treated so as to attract the received ink material while the periphery surfaces may repel the ink material. Additionally, heating elements (not shown) can be integrated with the discharge nozzle to assist in evaporating the carrier fluid prior to deposition.

To get the ink to preferentially wet the micropores compared to the non-discharge surfaces, the micropore sidewall surface and profile can be modified. For example the sidewalls can be smooth or rough, with different microstructures. The sidewall profile may be straight, slanted, or curved. The contour of the pore can also be modified; a pore with corners (such as a square for example) will be easier to fill than a round one.

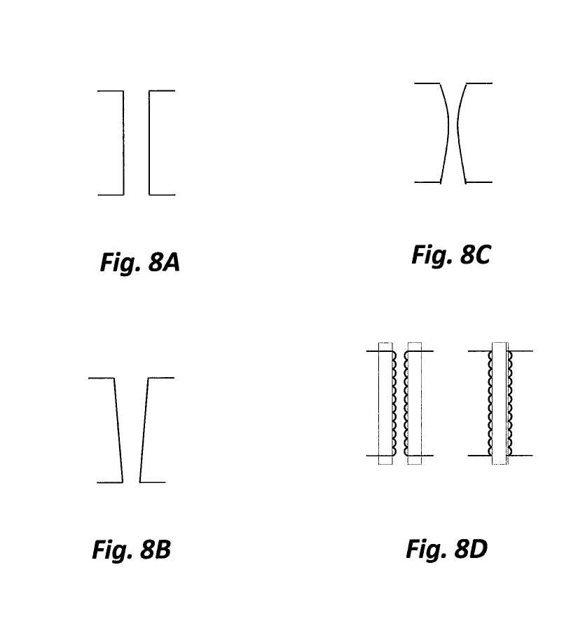

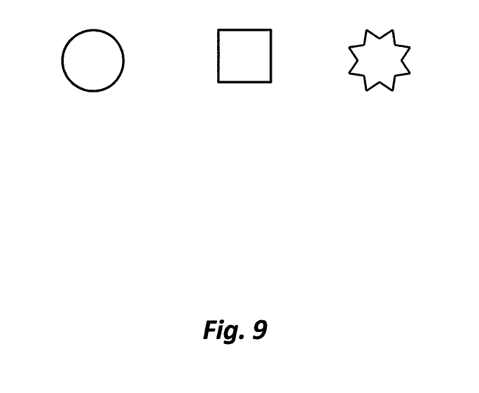

FIGS. 8A-8D schematically illustrate cross-sections of exemplary modified micropore structures. In particular, FIG. 8A shows a micropore having smooth, straight, sidewalls. FIG. 8B shows a micropore having tapered sidewalls. Depending on the application, the tapered end may be facing the substrate. Finally, FIG. 8C shows a micropore having curved sidewalls. FIG. 8D shows two micropores, each having a different interior portion. Here, the micropores are structured to have a contour which enables or enhances flow of ink material therethrough. The interior regions may further be chemically treated to be more attractive to the ink material. FIG. 9 schematically illustrates plan-view sections of exemplary micropores, which include round, square and star-shaped profiles.

While the principles of the disclosure have been illustrated in relation to the exemplary embodiments shown herein, the principles of the disclosure are not limited thereto and include any modification, variation or permutation thereof.

What is claimed is:

1. A method for loading film material into a discharge array having a surface and a plurality of micropores extending therethrough, the method comprising:
providing a quantity of liquid ink defined by a carrier fluid containing dissolved or suspended film material;
delivering the quantity of liquid ink onto the discharge array;
flowing a pressurized gas over the surface to drive the delivered ink material into at least one micropore;
removing the carrier fluid from the delivered ink to form a substantially carrier-free ink material at the micropore; and
dispensing the substantially carrier-free ink material from the at least one micropore;
wherein the surface rejects the liquid ink and the plurality of micropores receive the liquid ink.

2. The method of claim 1, wherein the steps delivering the liquid ink onto the discharge array and flowing a pressurized gas over the discharging array are implemented simultaneously.

3. The method of claim 1, wherein the step of dispensing the substantially carrier-free ink material from the micropore further comprises vaporizing the ink material at the micropore and directing the vaporized ink material to a substrate to form a substantially carrier-free film layer on the substrate.

4. The method of claim 1, wherein the pressurized gas is an inert gas.

5. The method of claim 1, wherein the surface is treated to repel liquid ink while the at least one micropore is treated to attract liquid ink.

6. The method of claim 5, wherein the surface is treated by one or more of physical, chemical or electro-chemical modification to the surface in order to repel liquid ink.

7. The method of claim 1, wherein the step of providing the quantity of liquid further comprises providing a plurality of liquid ink streams wherein each of the plurality of liquid ink streams corresponds with one of the plurality of micropores.

8. The method of claim 1, further comprising forming a layer of organic light emitting diode on a substrate from the substantially carrier-free ink material dispensed from the at least one micropore.

9. The method of claim 1, wherein flowing a pressurized gas over the surface further comprises sweeping a gas knife over the surface to distribute the delivered ink material across the surface and into the at least one micropore.

10. The method of claim 9, wherein the gas knife further includes a width and a length, the length being along the sweeping direction and being less than one third to total sweep distance, and the width being at long enough to ensure complete coverage of the surface throughput the sweep.

11. The method of claim 1, wherein the quantity of the delivered ink exceeds filling capacity of the at least one micropore.

12. The method of claim 1, wherein the step of flowing a pressurized gas over the discharging array is applied prior to the step of removing the carrier fluid.

13. The method of claim 1, wherein the steps of delivering the liquid ink onto the discharge array and flowing a pressurized gas over the discharging array are implemented substantially simultaneously.

14. An apparatus for loading ink material into discharge system, comprising:
an ink discharge system defined by an array having a surface and at a first micropore extending through at least a portion of the surface;
an ink supply for delivering liquid ink to the discharge system, the liquid ink defined by a carrier fluid containing dissolved or suspended film material therein;
a gas knife for directing pressurized gas to the surface and the first micropore to distribute liquid ink across the surface and into the first micropore; and
an energy source for evaporating the carrier fluid from the delivered liquid ink to thereby leave a substantially carrier-free film material in the first micropore;
wherein the micropore is configured to receive the ink and the surrounding surfaces are configured to repel the ink.

15. The apparatus of claim 14, further comprising an actuator for dispensing the substantially carrier-free film material from the first nozzle.

16. The apparatus of claim 15, wherein the actuator is a heater or a piezoelectric device.

17. The apparatus of claim 14, wherein the gas knife provides substantially inert gas.

18. The apparatus of claim 14, wherein the ink supply delivers sufficient ink to the fill the first micropore to capacity.

19. The apparatus of claim 14, further comprising a plurality of micropores.

20. The apparatus of claim 14, further comprising a substrate for receiving vaporized film material from the first micropore and condensing the vaporized film material to form a substantially carrier-free film layer on the substrate.

21. The apparatus of claim 14, further comprising dispensing the substantially carrier-free film by evaporating the dissolved or suspended film material and directing the vaporized film material onto a substrate.

22. The apparatus of claim 21, wherein the substantially solid film forms a substantially carrier-free layer of an organic light emitting diode on the substrate.

23. The apparatus of claim 14, wherein the gas knife applies a sweeping gas curtain over the surface and the micropore to drive the delivered liquid ink across the surface and into the first micropore.

24. The apparatus of claim 14, wherein the gas knife further includes a width and a length, the length being along a sweeping direction of the array and about less than one third of the total sweep distance, and the width extending to cover the width of the array.

25. The apparatus of claim 14, wherein the at least one micropore is a blind micropore.

26. A method for depositing a film material on a substrate, the method comprising:
supplying a quantity of liquid ink defined by a carrier fluid containing dissolved or suspended ink material to an array defined by a first surface having a plurality of blind micropores extending therethrough;
repelling the liquid ink from the first surface of the array toward a first of the plurality of blind micropores;
receiving the liquid ink at the first micropore;
flowing a pressurized gas over the surface to drive the liquid ink into the first micropore;
removing the carrier fluid from the delivered ink to form a substantially carrier-free ink material at the first micropore; and
dispensing the substantially carrier-free ink material from the at least one micropore to form the film on a substrate.

27. The method of claim 26, wherein the first surface is chemically treated to reject the liquid ink and the first micropore is chemically treated to receive the liquid ink.

28. The method of claim 26, wherein the first surface is etched to reject the liquid ink.

29. The method of claim 26, wherein the ink material defines a film material.

30. The method of claim 26, wherein the step of dispensing the substantially carrier-free ink material further comprises vaporizing the carrier-free ink material and directing the vaporized ink material onto a substrate.

31. The method of claim 30, wherein the vaporized ink material forms a substantially solid film of an organic light emitting diode on the substrate.
